(19) United States
(12) Patent Application Publication
(10) Pub. No.: US 2024/0220466 A1
(43) Pub. Date: Jul. 4, 2024

(54) ATTRIBUTE STORAGE, VIRTUALIZATION, AND MONITORING IN DATABASES

(71) Applicant: Salesforce, Inc., San Francisco, CA (US)

(72) Inventors: Ohad Barak, Ra'anana (IL); Prithvi Krishnan Padmanabhan, San Ramon, CA (US); Gary BRANDELEER, Mill Valley, CA (US)

(73) Assignee: Salesforce, Inc., San Francisco, CA (US)

(21) Appl. No.: 18/303,189

(22) Filed: Apr. 19, 2023

Related U.S. Application Data
(60) Provisional application No. 63/478,464, filed on Jan. 4, 2023.

(51) Int. Cl. G06F 16/22; G06F 16/215

(52) U.S. Cl. CPC G06F 16/22; G06F 16/215

(57) ABSTRACT

A method receives a definition for an attribute that is associated with an asset. Information from the asset is received for the attribute. A name for the attribute is received where the name is used as a key in a key value pair for the attribute in a database. The method stores a key value pair for the attribute in the database using the key of the name. The value is associated with the information received from the asset that is monitoring the attribute. Access is provided to the value for the attribute using the key to monitor the attribute for the asset.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### CROSS-REFERENCE TO RELATED APPLICATIONS

This application claims priority to, co-pending and commonly assigned U.S. Patent Application No. 63/478,464 by Barak et al., titled ATTRIBUTE STORAGE, VIRTUALIZATION, AND MONITORING IN DATABASES, filed on Jan. 4, 2023 (Attorney Docket No. SFDCP128P), which is hereby incorporated by reference in its entirety and for all purposes.

### FIELD OF TECHNOLOGY

This patent document relates generally to databases and more specifically to attribute storage in databases.

### BACKGROUND

A system may need to track and analyze large numbers of attributes for assets. For example, an asset manager may need to monitor multiple assets in different fields. In some examples, an asset may have multiple attributes that represent an asset's health and performance. In some examples, assets may be in the possession of customers and are monitored remotely. Monitoring asset attributes help mobile workers better understand the condition of the asset and let them maintain and repair those assets in the field more efficiently. The monitoring of attributes also enables asset managers to shift to proactive, and predictive, service models that promote higher uptime and compliance for the assets.

The attributes for an asset may be difficult to scale in a database, such as a Structured Query Language (SQL) database. Typically, an asset may be stored on a row in the database, and the attributes are stored in columns. The database may limit by the number of available columns. Thus, for an asset, the number of attributes may be limited by the number of columns supported by the database.

### BRIEF DESCRIPTION OF THE DRAWINGS

The included drawings are for illustrative purposes and serve only to provide examples of possible structures and operations for the disclosed inventive systems, apparatus, methods and computer program products for storing attributes in databases. These drawings in no way limit any changes in form and detail that may be made by one skilled in the art without departing from the spirit and scope of the disclosed implementations.

FIG. 1 depicts a simplified system for storing data for attributes according to some embodiments.

FIG. 2 depicts an example of an asset with respective attributes according to some embodiment.

FIG. 3 depicts a simplified flowchart of a method for creating attribute definitions according to some embodiments.

FIG. 4 depicts a simplified flowchart of a method for creating asset attributes according to some embodiments.

FIG. 5 depicts an example of a model of the storage of an asset and its attributes in a database according to some embodiments.

FIG. 6 depicts a simplified flowchart of a method for creating recordset filter criteria monitoring rules according to some embodiments.

FIG. 7 depicts an example of a model for the storage of recordset filter criteria monitoring rules in the database according to some embodiments.

FIG. 8 depicts a simplified flowchart of a method for monitoring the recordset filter criteria monitoring rules according to some embodiments.

FIG. 9 shows a block diagram of an example of an environment that includes an on-demand database service configured in accordance with some implementations.

FIG. 10A shows a system diagram of an example of architectural components of an on-demand database service environment, configured in accordance with some implementations.

FIG. 10B shows a system diagram further illustrating an example of architectural components of an on-demand database service environment, in accordance with some implementations.

FIG. 11 illustrates one example of a computing device.

### DETAILED DESCRIPTION

### Overview

A database system may store data for attributes as key value pairs using table rows instead of columns. Each attribute may have an attribute definition that defines a name and a value. The name may describe the attribute, such as relative humidity or temperature, and the value is for an attribute that is received from the asset. The attribute definition may also define characteristics for the attribute, such as a data type for the value (e.g., a number) and a unit of measure for the value (e.g., a percentage). Also, the database system may virtualize the interface with the key value pairs to improve the interaction with devices that are accessing the data. For example, a virtual object may be created for data stored in key value pairs in a database. The virtualization may make the access transparent to a consumer device, and the use of the attributes may be similar to the use when storing attributes in a column approach. The virtual objects interfaces with the storage and allows operations, such as create, read, update, and delete (CRUD) operations, as well as enables the user interface layer to perform operations, as if the storage was columnar.

In some examples, an asset manager may want to monitor an asset, such as a heating, ventilation and air conditioning (HVAC) system. The asset manager may define attributes that represent asset health and performance of the HVAC system. After defining asset attributes, the asset manager can define threshold monitoring based on recordset filter criteria and track threshold compliance for multiple asset attributes. A mobile worker may monitor the compliance and receive alerts when thresholds are not within threshold. The mobile worker can troubleshoot the asset using the data stored in the key value pairs for the asset.

The use of key value pairs improves the storage of asset attributes by removing the limitation on the number of columns that can be stored for an asset. For example, the use of key value pairs allows the attributes to be stored in rows at scale in real time. This improves the storage and use of different assets, such as assets stored in energy and utilities, manufacturing, automotive, revenue, media, service, field service, insurance, and other industries. The key value pairs can be used to extend a variety of attributes, such as asset name, order, quote line item, contract, contract line item, and many more attributes. The number of attributes that can be used can be scaled without any limit on the number of columns that can be stored for an asset.

### System

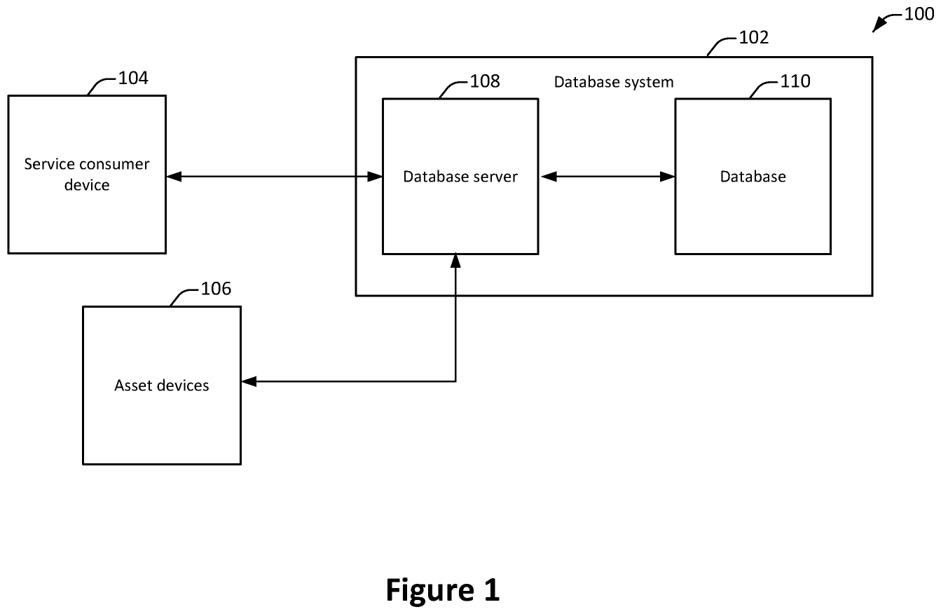

FIG. 1 depicts a simplified system 100 for storing data for attributes according to some embodiments. System 100 includes a database system 102, a service consumer device 104, asset devices 106, a database server 108, and a database 110. Although single instances of the entities in system 100 are shown, different numbers of instances may be appreciated. For example, there may be multiple database servers, databases, asset devices, and service consumer devices. In some embodiments, database system 102 may be implemented as a cloud environment or multi-tenant database, which will be described below in more detail.

Database server 108 may be used to access data stored on database 110. Database 110 may be configured to respond to queries for data. In some embodiments, database 110 stores data in tables using key value pairs. Database 110 may have a restriction on the number of columns that can be used for a row. For example, there may be a limit of 800 available columns for a row.

Service consumer device 104 may be a device that accesses services provided by database system 102. In some embodiments, service consumer device 104 may be a client device, application server, mobile device, computer, etc.

Asset devices 106 may be devices that have attributes. For example, asset devices 106 may be Internet of Things devices, automobiles, devices in industries such as energy and utilities, manufacturing, automotive, media services, field services, insurance, and other industries, etc. An example of an asset device 106 may be an HVAC system. Attributes for the HVAC system may be relative humidity, temperature, air direction, etc.

Service consumer device 104 may be used for different purposes, such as to configure asset attributes for asset devices 106 in database system 102 and/or use the attributes to monitor asset devices 106. An asset manager may configure the definition of asset devices 106 and respective attributes for the asset devices 106 in database 110. The asset manager may configure key value pairs to store data for the attributes in database 110. For example, the asset manager may configure objects for attributes that are stored in database 110. As will be described in more detail, a virtual object and a standard object may be created in database 110. The virtual object may provide a virtualized view of the standard object.

Once definitions for the attributes are configured, an asset manager may use a service consumer device 104 to set monitoring rules to monitor data for attributes in database 110. For example, the asset manager may set monitoring criteria for asset devices 106. In some examples, the asset manager may set Recordset filter criteria monitoring rules that include criteria and thresholds. An asset manager can define Recordset Filter Criteria Monitoring (RFCM) rules that monitor an asset by considering one or more asset attributes that are filtered by recordset filter criteria. The filter criteria may define asset attributes, and thresholds for the values of the asset attributes. The monitoring determines values for the asset attributes associated with the filter criteria, and determines if the values comply with the thresholds defined by filter criteria. For example, an asset manager may wish to monitor attributes of an HVAC system. The asset manager may set thresholds for attributes to monitor. Some examples of attributes may include relative humidity, temperature, and air direction. For example, the asset manager may wish to monitor when humidity is less than 21% and the temperature is less than 70 degrees. The asset manager may then set the recordset filter criteria monitoring rules in database system 102 to perform the above monitoring.

Database server 108 may receive data from the HVAC system and store data for the attributes in database 110 using the key value pairs. For example, as the relative humidity and temperature change, such as from a relative humidity of 19 to 20 and a temperature of 68 to 69, database server 108 may store the changed values in the key value pairs in database 110. Then, database server 108 compares the values to thresholds. When thresholds are met (e.g., conditions are outside of threshold), database server 108 may perform an action, such as output an alert. When the threshold is within the threshold, the device may be operating within a desired range, and no alert may be output.

### Attribute Example

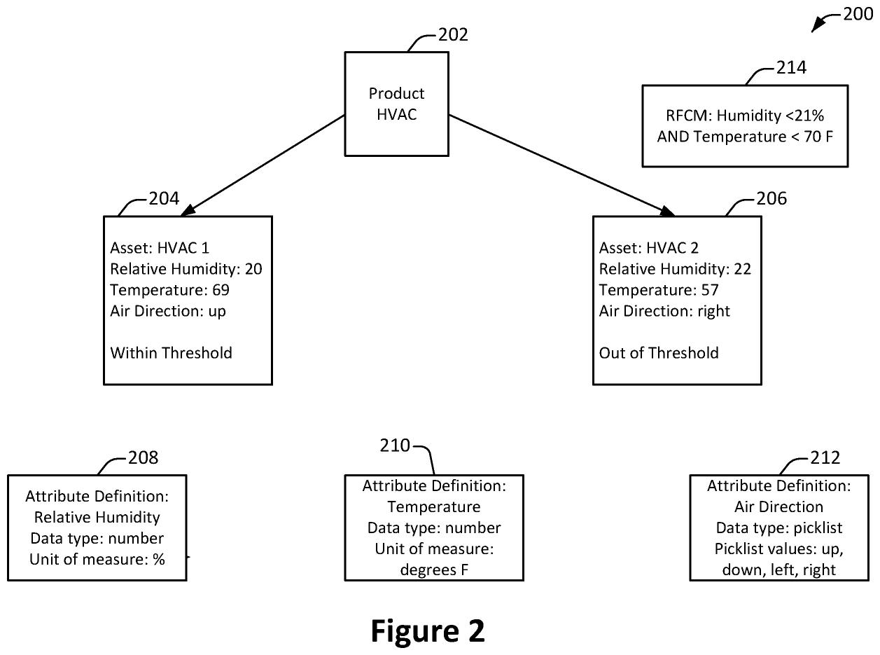

FIG. 2 depicts an example 200 of an asset with respective attributes according to some embodiment. In this example, the asset may be a product that is an HVAC system at 202. There may be two instances of the asset in this case of HVAC 1 at 204 and HVAC 2 at 206. The attributes may include relative humidity, temperature, and air direction for both assets. The attributes of relative humidity, temperature, and air direction may have different attribute definitions at 208, 210, and 212, respectively. For example, at 208, relative humidity may have a data type of a number and a unit of measure in a percentage; at 210, the temperature attribute may have a data type of a number and a unit of measure in degrees Fahrenheit; and at 212, the air direction attribute may have a data type of a pick list, pick list values of up and down, right and left.

An asset manager may define rules, such as recordset filter criteria monitoring (RFCM) rules at 214, that monitor an asset by considering one or more attributes filtered by the recordset filter criteria. The recordset filter criteria monitoring rule may use thresholds defined by the rule and determine whether the values for the attributes meet the thresholds, such as are within defined thresholds or out of the threshold. The filter criteria may select records for attributes in database 110 using a key for the attributes, and retrieve the values for the attributes. Then, the rule may compare the values to thresholds that are set for the recordset filter criteria monitoring rules.

In this example, the recordset filter criteria monitoring rule at 214 may be set for detecting whether humidity is less than 21% and temperature is less than 70%. In this case, the asset HVAC 1 has a relative humidity of 20 and a temperature of 69 degrees Fahrenheit. The second asset, HVAC 2, has a relative humidity of 22 and a temperature of 67. The asset HVAC 1 is within the threshold and the asset HVAC 2 is out of the threshold. The asset HVAC 1 is within threshold because the relative humidity is less than 21% and the temperature is less than 70, which meets both conditions. However, the asset HVAC 2 has a relative humidity that is 22%, which is greater than the humidity threshold of 21%. Thus, the asset HVAC 2 is out of the threshold because one of the conditions is not met. Although HVAC systems are described, other devices may be used. In another example, if an engine is being monitored, an asset manager may define a threshold based on attributes such as engine temperature, engine pressure, engine oil level, engine air influx, and revolutions per minute (RPMs). The asset manager can set recordset filter criteria monitoring rules that then monitor the engine for faults by monitoring values for these attributes.

### Attribute Definition and Asset Attributes

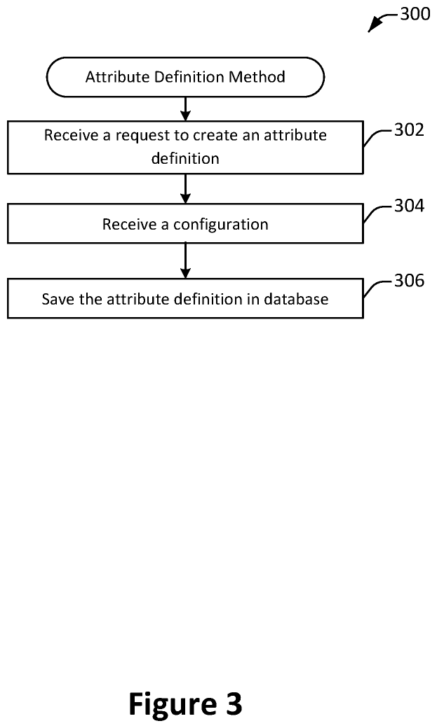

FIG. 3 depicts a simplified flowchart 300 of a method for creating attribute definitions according to some embodiments. At 302, database system 102 receives a request to create an attribute definition. The request may include a name for the attribute definition, such as “Relative Humidity”. As will be discussed below, the name may be used as a key in the database. The name may be unique in database 110 such that the name can be used to identify a corresponding value. At 304, database system 102 may receive a configuration. For example, the configuration may configure the value, such as a data type for the value. The input may be a “number”, which indicates the value of the attribute may be a number. If number is selected, then the unit of measure may also be received, such as “%”, which indicates the value will be a percentage (e.g., 21% Humidity). Also, a “picklist” may be used, which displays a picklist for selection. At 306, database system 102 saves the attribute definition in database 110. Attribute definitions may be created for multiple attributes, such as the attribute definitions for relative humidity, temperature, and air direction in FIG. 2.

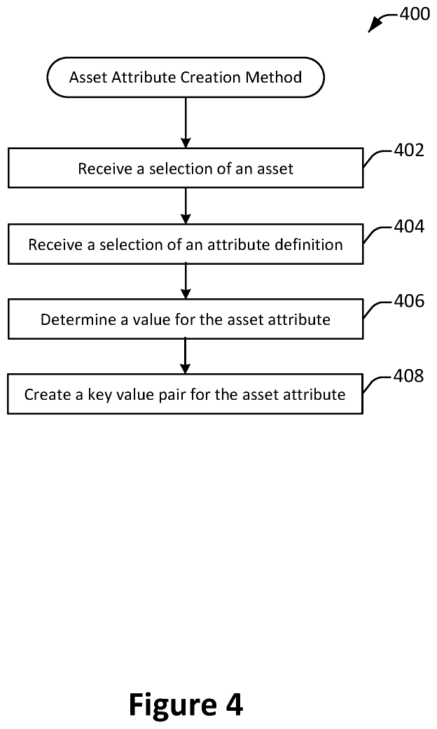

Asset attributes for an asset may be created using attribute definitions. FIG. 4 depicts a simplified flowchart 400 of a method for creating asset attributes according to some embodiments. At 402, database system 102 receives a selection of an asset. For example, a selection of the asset of a HVAC 1 or HVAC 2 may be received.

At 404, database system 102 receives a selection of an asset attribute associated with an attribute definition. For example, attributes that are associated with available attribute definitions may be displayed, and one of the asset attributes is selected. In some examples, the attributes or relative humidity, temperature, air direction, etc. are displayed. At 406, database system 102 determines a value for the asset attribute. For example, a number may be received, such as 20%. Also, if no value is received, a default value that is defined in the attribute definition may be used. If the data type is a picklist, then a selection of one of the values for the picklist may be received, such as up, down, left, and right.

At 408, database system 102 creates a key value pair for the asset attribute. The key may be the name of the asset attribute and the value may be stored in a value field for the key. As will be described below, as the asset is monitored, the value may be changed.

### Asset Definition Storage

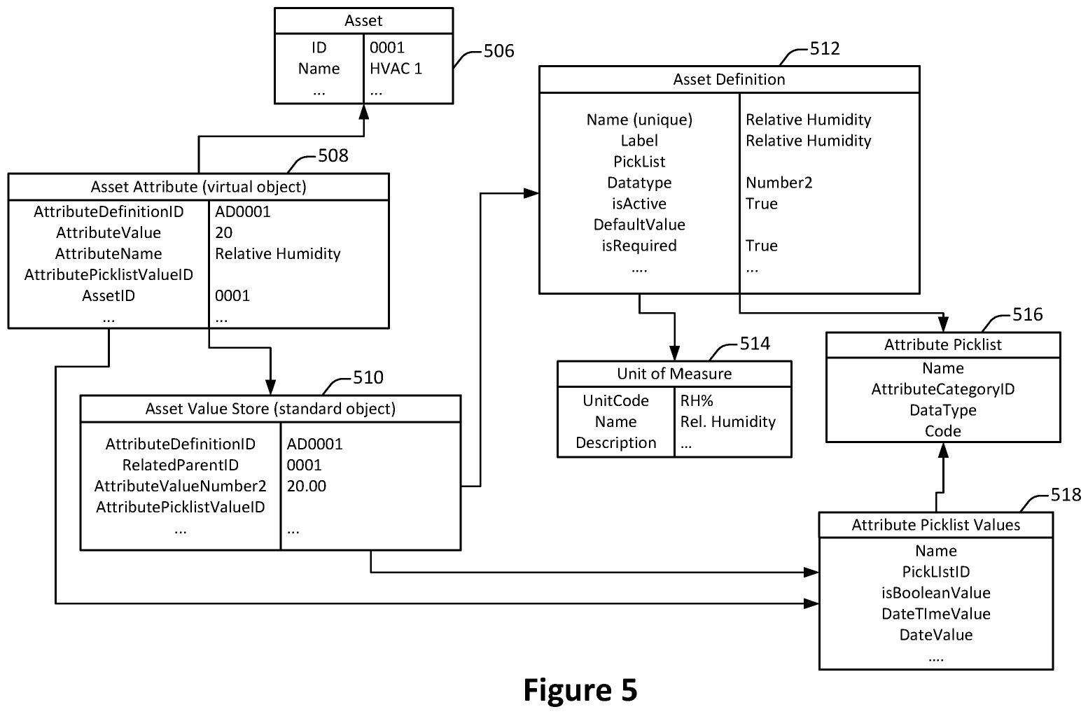

FIG. 5 depicts an example of a model of the storage of an asset and its attributes in database 110 according to some embodiments. The assets of HVAC 1 and HVAC 2 that were described in FIG. 2 are being used as an example of storing data for the asset definition. The following example shows a conceptual definition for storing data for the relative humidity attribute monitoring for asset HVAC 1. As a reminder, at 204 in FIG. 2, the relative humidity is 20, the temperature is 69 degrees, and the air direction is up, which are values that are detected from HVAC 1.

At 506, an entity shows the information for the asset that may be stored in a table. For example, a field of ID indicates an identifier for the asset of “0001” and a field of Name indicates the asset name of HVAC 1. The ID may be the primary key for the asset.

Database system 102 may create a virtual object and a standard object for an asset attribute. For example, at 508, an entity for the virtual object is shown for the asset attribute. The virtual object may be an interface that allows the asset manager to perform operations using a columnar approach and allows the asset manager to generate recordset filter criteria monitoring rules. For example, fields are listed for information that is stored for the asset attribute. The field of AttributeDefinitionID is the identifier for the asset attribute and has a value of “AD0001” for this attribute. The field of AttributeValue stores the value of “20” for the asset attribute. The field of attribute name stores the key of “Relative Humidity”. In some examples, the current value for the relative humidity is 20%. This may mean the asset HVAC 1 has detected a relative humidity of 20% and sent the value to database system 102. The asset ID has a value of “0001”, which may be a foreign key that points to the asset at 506. In some embodiments, the key for the virtual object may be the attribute name of “Relative Humidity”, and value of the virtual object is the attribute value of “20”.

At 510, a standard object is stored in database 110. The standard object may refer to the virtual object using a field of AttributeDefinitionID with a value of AD0001, which is a foreign key to the virtual object at 508. Also, the field of RelatedParentID has the value of 0001, which may be a foreign key that indicates the standard object refers to the asset with the ID of 0001 at 506. That is, the standard object may include data stored for the virtual object with the attribute definition ID of AD0001. The field of AttributeValueNumber2 stores the value of 20.00 for the attribute of Relative Humidity. The standard object may also store other information, such as a date, time, etc.

One improvement in using the virtual object is because the virtual object may simplify the access of the attribute for the asset manager by providing an interface to keys and values that may be used to set monitoring rules. The storage of the keys and values in the standard object may be abstracted using the virtual object, and access may be similar as using a row and column approach. Without the virtual objects, service consumer device 104 would have to access the storage directly by accessing rows and not columns to perform operations, which may be a non-standard approach. This non standard approach may confuse users and developers as it would have require deviation from standard usage of the system. With the virtual objects, row access of standard objects is translated (transparently to users and developers) to columnar access, enabling standard behavior. In this way, service consumer device 104 can perform operations that appear to access columns, where the virtual object uses references to the standard object to translate the operations to access key value pairs stored in rows.

To define the asset attribute, an attribute definition may be used at 512. In this case, the name of the attribute is Relative Humidity and includes a label of Relative Humidity. The name may be unique in database 110. The data type is defined as a number, and value for the asset attribute can be a number. At 514, the unit of measure for the attribute is shown for Relative Humidity as a percentage (%).

The asset attribute may be defined using different configurations. For example, at 516, an attribute picklist may be defined. At 518, the pick list values may also be defined. Other definitions for the attribute values may also be appreciated.

Attribute definitions for other attributes may also be stored, such as for temperature and air direction. The attributes may be added based on key value pairs as described above instead of as columns in a table. This does not limit the number of attributes that can be stored for the asset.

Recordset filter Criteria Monitoring Rules

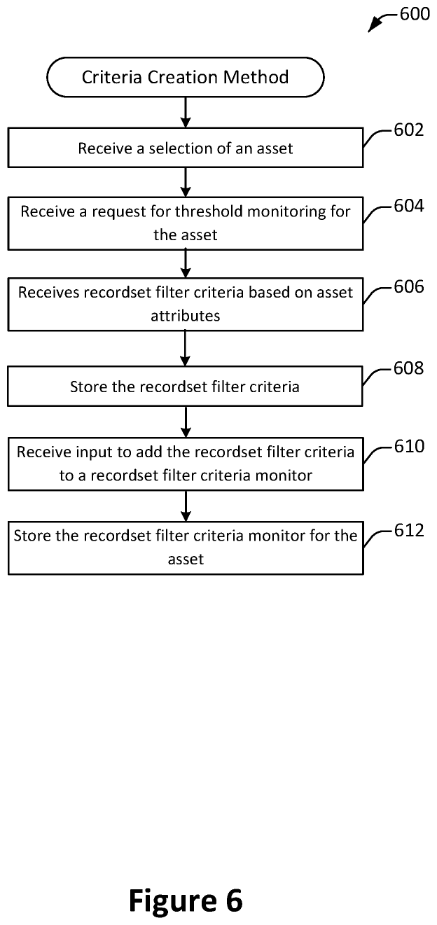

After defining asset attributes, recordset filter criteria monitoring rules may also be set for the asset. FIG. 6 depicts a simplified flowchart of a method for creating recordset filter criteria monitoring rules according to some embodiments. At 602, database system 102 receives a selection of an asset. For example, a selection of the asset of HVAC 1 is received. At 604, a request for threshold monitoring is received for the asset.

At 606, database system 102 receives recordset filter criteria based on asset attributes. For example, database system 102 receives a selection of an attribute of the asset, such as relative humidity. Also, the condition, such as lower than, and the value, such as 20, may be received. The above creates a recordset filter criteria. At 608, database system 102 stores the recordset filter criteria.

At 610, database system 102 receives input to add the recordset filter criteria to a recordset filter criteria monitoring rule. The enabling of the rule initiates monitoring of the asset attribute. At 612, database system 102 then stores the recordset filter criteria monitoring rule for the asset.

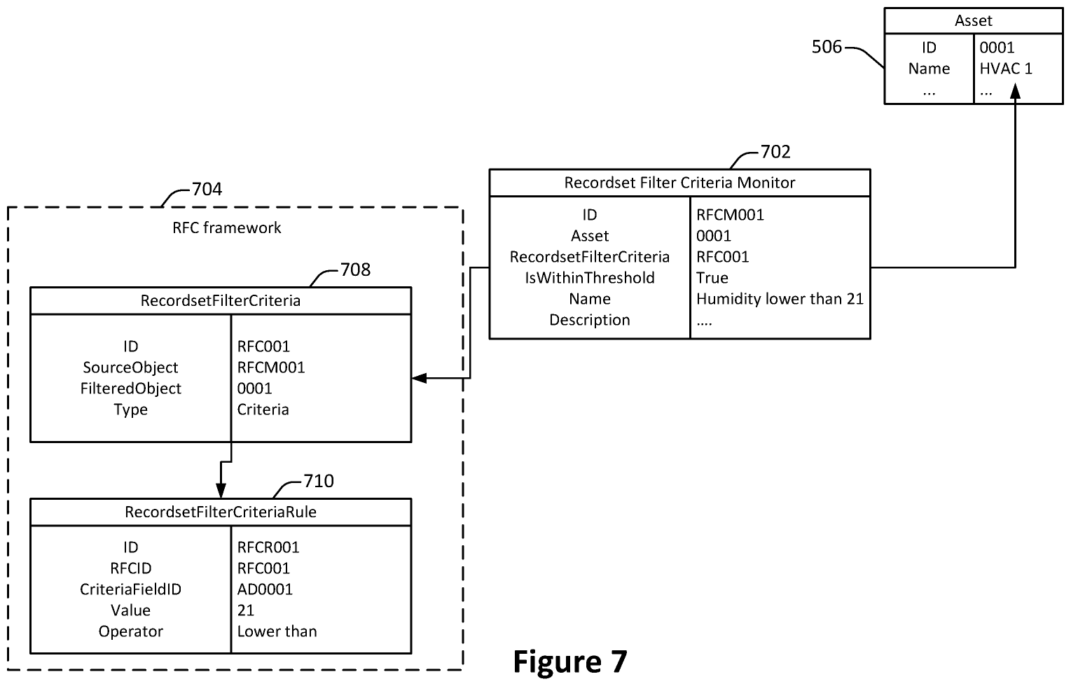

FIG. 7 depicts an example of a model for the storage of recordset filter criteria monitoring rules in database 110 according to some embodiments. At 506, the asset of HVAC 1 is listed from FIG. 5. At 702, a recordset filter criteria monitoring rule is stored for relative humidity. A field of ID stores the value of the recordset filter criteria monitor of “RFCM001”, which identifies the rule. A field of “Asset” stores a value of an asset ID of “0001”. The asset ID may be a foreign key that points to the asset at 506 in FIG. 5 of HVAC 1.

The threshold may be set as humidity lower than 21, which determines whether or not the humidity is lower than 21 is true. For example, a field of “isWithinThreshold” has a value of “True” to set a condition of the rule that the value needs to be within the threshold. The field of “Name” has a value of “Humidity lower than 21” to set the name of the rule.

At 704, an RFC framework may store a definition for the recordset filter criteria. In this case, at 708, an object of “RecordsetFilterCriteria” is created for the rule. The field of ID has a value of “RFC001” to identify the rule. The field of “SourceObject” has a value of “RFCM001” to identify the recordset filter criteria monitoring rule. The field of “FilteredObject” has a value of “0001”, which is a foreign key that points to the asset ID of “0001” at 506.

The value and the operator may be stored for the rule. At 710, an object of “RecordsetFilterCriteriaRule” may identify the rule with a field of ID and a value of “RFCR001”. The field of “RFCId” has a value of RFC001, which may be a foreign key that identifies the ID of object of “RecordsetFilterCriteria”. Then, the value for the threshold is set using a field of “CriteriaFieldId”, which is set to a value of “AD0001”, which refers to the asset attribute. A field of “Value” lists the value of “21” for the threshold value. The rule can refer to the asset attribute to determine the current value to evaluate the rule. For example, when a change in the value of the asset attribute occurs, the recordset filter criteria monitoring rule is applied to the new value. An operator to apply to a monitored value for the asset to the threshold is defined using a field of “Operator” with a value of “lower than”. Accordingly, the criteria may be when the monitored value of the relative humidity is lower than 21, the relative humidity is within threshold. Other recordset filter criteria monitoring rules may also be appreciated, such as setting a rule for monitoring whether temperature less than 70.

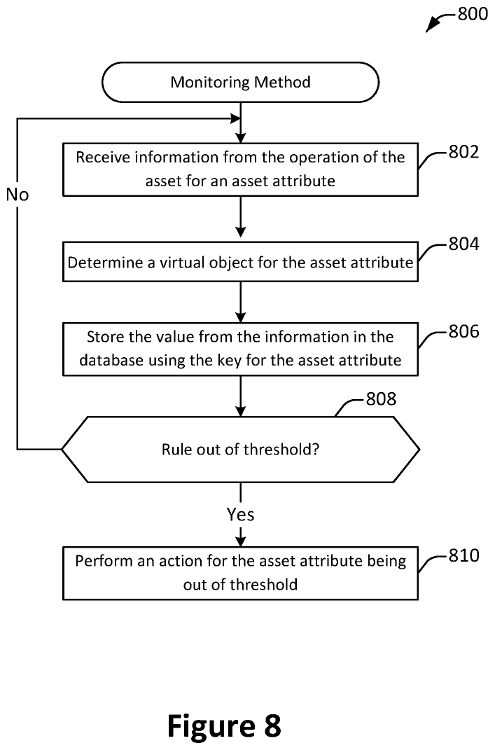

Once setting the recordset filter criteria monitoring rules, database system 102 may monitor the rules. FIG. 8 depicts a simplified flowchart 800 of a method for monitoring the recordset filter criteria monitoring rules according to some embodiments. At 802, database system 102 receives information from the operation of the asset for an asset attribute. For example, the relative humidity that is detected by HVAC 1 may be received. Other information may be received, such as the temperature and the air direction that is detected.

At 804, database system 102 determines a key for the asset attribute. For example, an asset attribute Name from the information is used to determine a virtual object. At 806, database system 102 stores the value from the information in database 110 using the key for the asset attribute. For example, database system 102 may store the value of 20 for the key of Name. Database system 102 may also store the value in the standard object. For example, database system 102 stores the value for the key. In the standard object, the key value pair is stored according to its data type, in the example, it is stored as AttributeValueNumber2 which means 20.00 (two decimal point precision-). The virtual object of Asset Attribute is an interface and may not store the value, but allows access to the value in the standard object.

At 808, database system 102 determines if the recordset filter criteria monitoring rule is out of the threshold. If not, the process continues to monitor the value for the asset attribute. If the value is out of the threshold, then at 810, database system 102 performs an action for the asset attribute being out of the threshold. For example, database system 102 may output an alert the out of the threshold condition is being experienced. Also, other remedial actions may be taken, such as shutting down the asset, changing settings, etc.

### CONCLUSION

Accordingly, attributes may be stored using key value pairs. The key may be the name of the attribute and the value is associated with the name. This allows the number of attributes that are stored in database 110 to scale without restrictions on the number of columns. The virtualization and visualization of attributes creates a uniform user experience. Tracking changes to attributes in real-time to generate reports if values for attributes cross thresholds is enabled. The conditions of attributes can be visualized in real-time so users can quickly identify an anomaly in conjunction with different attributes.

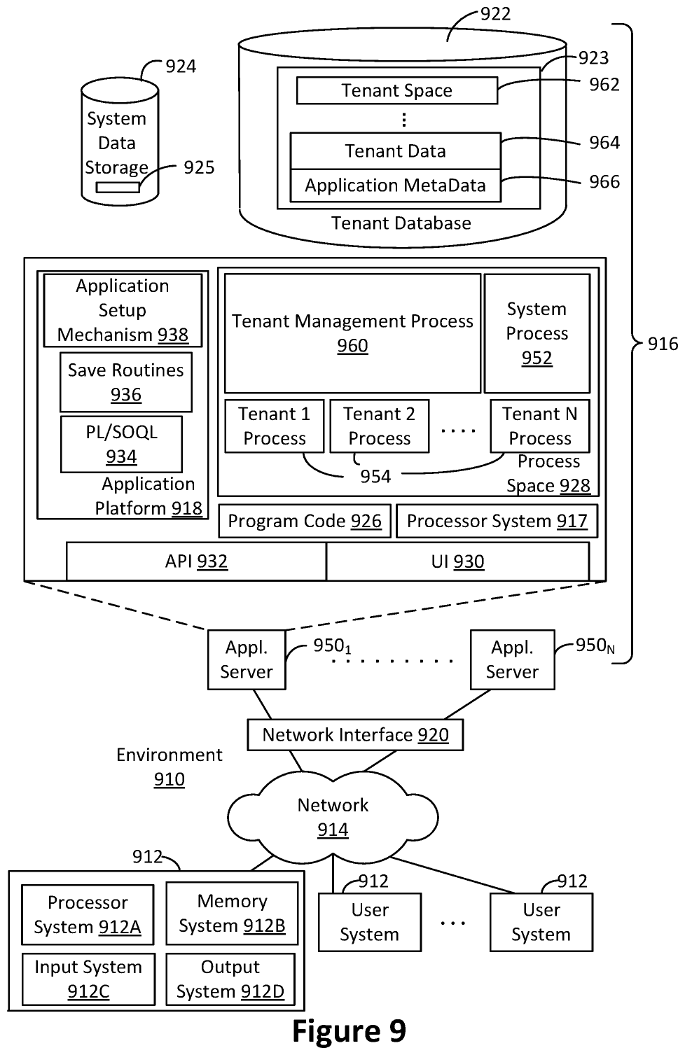

FIG. 9 shows a block diagram of an example of an environment 910 that includes an on-demand database service configured in accordance with some implementations. Environment 910 may include user systems 912, network 914, database system 916, processor system 917, application platform 918, network interface 920, tenant data storage 922, tenant data 923, system data storage 924, system data 925, program code 926, process space 928, User Interface (UI) 930, Application Program Interface (API) 932, PL/SOQL 934, save routines 936, application setup mechanism 938, application servers 950-1 through 950 -N, system process space 952, tenant process spaces 954, tenant management process space 960, tenant storage space 962, user storage 964, and application metadata 966. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 916, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 918 may be a framework that allows the creation, management, and execution of applications in system 916. Such applications may be developed by the database service provider or by users or third-party application developers accessing the service. Application platform 918 includes an application setup mechanism 938 that supports application developers' creation and management of applications, which may be saved as metadata into tenant data storage 922 by save routines 936 for execution by subscribers as one or more tenant process spaces 954 managed by tenant management process 960 for example. Invocations to such applications may be coded using PL/SOQL 934 that provides a programming language style interface extension to API 932. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 966 for a subscriber making such an invocation. Such system processes may also manage execution of application metadata 966 as an application in a virtual machine.

In some implementations, each application server 950 may handle requests for any user associated with any organization. A load balancing function (e.g., an F5 Big-IP load balancer) may distribute requests to the application servers 950 based on an algorithm such as least-connections, round robin, observed response time, etc. Each application server 950 may be configured to communicate with tenant data storage 922 and the tenant data 923 therein, and system data storage 924 and the system data 925 therein to serve requests of user systems 912. The tenant data 923 may be divided into individual tenant storage spaces 962, which can be either a physical arrangement and/or a logical arrangement of data. Within each tenant storage space 962, user storage 964 and application metadata 966 may be similarly allocated for each user. For example, a copy of a user's most recently used (MRU) items might be stored to user storage 964. Similarly, a copy of MRU items for an entire tenant organization may be stored to tenant storage space 962. A UI 930 provides a user interface and an API 932 provides an application programming interface to system 916 resident processes to users and/or developers at user systems 912.

System 916 may implement a web-based storage system. For example, in some implementations, system 916 may include application servers configured to implement and execute software applications. The application servers may be configured to provide related data, code, forms, web pages and other information to and from user systems 912. Additionally, the application servers may be configured to store information to, and retrieve information from a database system. Such information may include related data, objects, and/or Webpage content. With a multi-tenant system, data for multiple tenants may be stored in the same physical database object in tenant data storage 922, however, tenant data may be arranged in the storage medium(s) of tenant data storage 922 so that data of one tenant is kept logically separate from that of other tenants. In such a scheme, one tenant may not access another tenant's data, unless such data is expressly shared.

Several elements in the system shown in FIG. 9 include conventional, well-known elements that are explained only briefly here. For example, user system 912 may include processor system 912A, memory system 912B, input system 912C, and output system 912D. A user system 912 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 912 to access, process and view information, pages and applications available from system 916 over network 914. Network 914 may be any network or combination of networks of devices that communicate with one another, such as any one or any combination of a LAN (local area network), WAN (wide area network), wireless network, or other appropriate configuration.

The users of user systems 912 may differ in their respective capacities, and the capacity of a particular user system 912 to access information may be determined at least in part by “permissions” of the particular user system 912. As discussed herein, permissions generally govern access to computing resources such as data objects, components, and other entities of a computing system, such as an asset attribute storage system, a social networking system, and/or a CRM database system. “Permission sets” generally refer to groups of permissions that may be assigned to users of such a computing environment. For instance, the assignments of users and permission sets may be stored in one or more databases of System 916. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 916 may provide on-demand database service to user systems 912 using an MTS arrangement. By way of example, one tenant organization may be a company that employs a sales force where each salesperson uses system 916 to manage their sales process. Thus, a user in such an organization may maintain contact data, leads data, customer follow-up data, performance data, goals and progress data, etc., all applicable to that user's personal sales process (e.g., in tenant data storage 922). In this arrangement, a user may manage his or her sales efforts and cycles from a variety of devices, since relevant data and applications to interact with (e.g., access, view, modify, report, transmit, calculate, etc.) such data may be maintained and accessed by any user system 912 having network access.

When implemented in an MTS arrangement, system 916 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 916 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 916 may also maintain system-level data usable by multiple tenants or other data. Such system-level data may include industry reports, news, postings, and the like that are sharable between tenant organizations.

In some implementations, user systems 912 may be client systems communicating with application servers 950 to request and update system-level and tenant-level data from system 916. By way of example, user systems 912 may send one or more queries requesting data of a database maintained in tenant data storage 922 and/or system data storage 924. An application server 950 of system 916 may automatically generate one or more SQL statements (e.g., one or more SQL queries) that are designed to access the requested data. System data storage 924 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

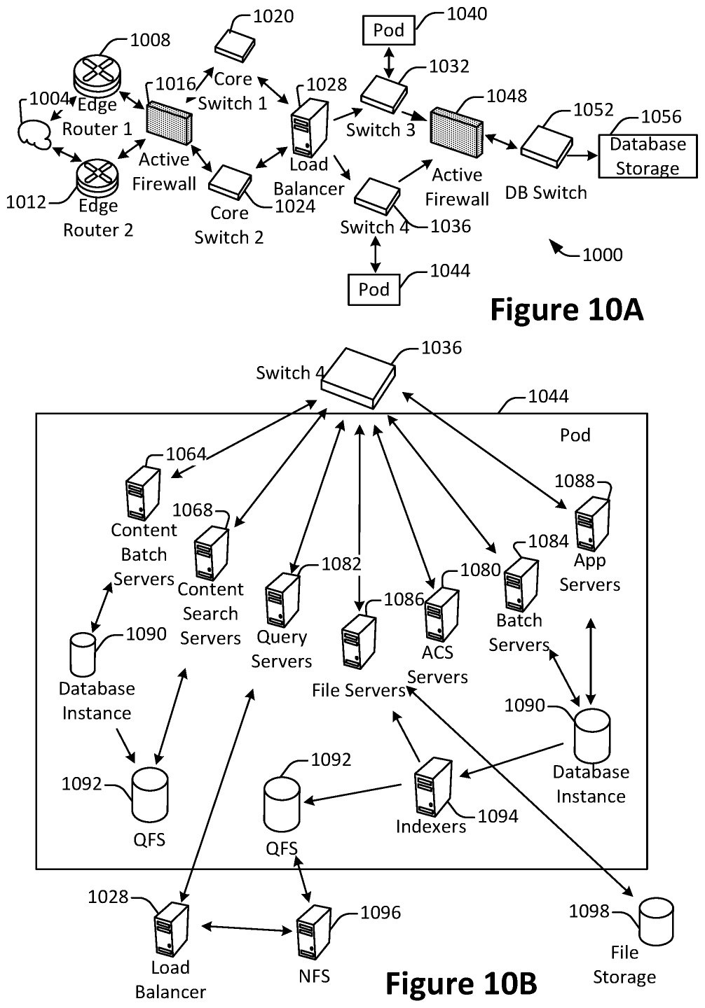

FIG. 10A shows a system diagram of an example of architectural components of an on-demand database service environment 1000, configured in accordance with some implementations. A client machine located in the cloud 1004 may communicate with the on-demand database service environment via one or more edge routers 1008 and 1012. A client machine may include any of the examples of user systems 912 described above. The edge routers 1008 and 1012 may communicate with one or more core switches 1020 and 1024 via firewall 1016. The core switches may communicate with a load balancer 1028, which may distribute server load over different pods, such as the pods 1040 and 1044 by communication via pod switches 1032 and 1036. The pods 1040 and 1044, which may each include one or more servers and/or other computing resources, may perform data processing and other operations used to provide on-demand services. Components of the environment may communicate with a database storage 1056 via a database firewall 1048 and a database switch 1052.

Accessing an on-demand database service environment may involve communications transmitted among a variety of different components. The environment 1000 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 10A and 10B.

The cloud 1004 refers to any suitable data network or combination of data networks, which may include the Internet. Client machines located in the cloud 1004 may communicate with the on-demand database service environment 1000 to access services provided by the on-demand database service environment 1000. By way of example, client machines may access the on-demand database service environment 1000 to retrieve, store, edit, and/or process asset attribute information.

In some implementations, the edge routers 1008 and 1012 route packets between the cloud 1004 and other components of the on-demand database service environment 1000. The edge routers 1008 and 1012 may employ the Border Gateway Protocol (BGP). The edge routers 1008 and 1012 may maintain a table of IP networks or ‘prefixes’, which designate network reachability among autonomous systems on the internet.

In one or more implementations, the firewall 1016 may protect the inner components of the environment 1000 from internet traffic. The firewall 1016 may block, permit, or deny access to the inner components of the on-demand database service environment 1000 based upon a set of rules and/or other criteria. The firewall 1016 may act as one or more of a packet filter, an application gateway, a stateful filter, a proxy server, or any other type of firewall.

In some implementations, the core switches 1020 and 1024 may be high-capacity switches that transfer packets within the environment 1000. The core switches 1020 and 1024 may be configured as network bridges that quickly route data between different components within the on-demand database service environment. The use of two or more core switches 1020 and 1024 may provide redundancy and/or reduced latency.

In some implementations, communication between the pods 1040 and 1044 may be conducted via the pod switches 1032 and 1036. The pod switches 1032 and 1036 may facilitate communication between the pods 1040 and 1044 and client machines, for example via core switches 1020 and 1024. Also or alternatively, the pod switches 1032 and 1036 may facilitate communication between the pods 1040 and 1044 and the database storage 1056. The load balancer 1028 may distribute workload between the pods, which may assist in improving the use of resources, increasing throughput, reducing response times, and/or reducing overhead. The load balancer 1028 may include multilayer switches to analyze and forward traffic.

In some implementations, access to the database storage 1056 may be guarded by a database firewall 1048, which may act as a computer application firewall operating at the database application layer of a protocol stack. The database firewall 1048 may protect the database storage 1056 from application attacks such as structure query language (SQL) injection, database rootkits, and unauthorized information disclosure. The database firewall 1048 may include a host using one or more forms of reverse proxy services to proxy traffic before passing it to a gateway router and/or may inspect the contents of database traffic and block certain content or database requests. The database firewall 1048 may work on the SQL application level atop the TCP/IP stack, managing applications' connection to the database or SQL management interfaces as well as intercepting and enforcing packets traveling to or from a database network or application interface.

In some implementations, the database storage 1056 may be an on-demand database system shared by many different organizations. The on-demand database service may employ a single-tenant approach, a multi-tenant approach, a virtualized approach, or any other type of database approach. Communication with the database storage 1056 may be conducted via the database switch 1052. The database storage 1056 may include various software components for handling database queries. Accordingly, the database switch 1052 may direct database queries transmitted by other components of the environment (e.g., the pods 1040 and 1044) to the correct components within the database storage 1056.

FIG. 10B shows a system diagram further illustrating an example of architectural components of an on-demand database service environment, in accordance with some implementations. The pod 1044 may be used to render services to user(s) of the on-demand database service environment 1000. The pod 1044 may include one or more content batch servers 1064, content search servers 1068, query servers 1082, file servers 1086, access control system (ACS) servers 1080, batch servers 1084, and app servers 1088. Also, the pod 1044 may include database instances 1090, quick file systems (QFS) 1092, and indexers 1094. Some or all communication between the servers in the pod 1044 may be transmitted via the switch 1036.

In some implementations, the app servers 1088 may include a framework dedicated to the execution of procedures (e.g., programs, routines, scripts) for supporting the construction of applications provided by the on-demand database service environment 1000 via the pod 1044. One or more instances of the app server 1088 may be configured to execute all or a portion of the operations of the services described herein.

In some implementations, as discussed above, the pod 1044 may include one or more database instances 1090. A database instance 1090 may be configured as an MTS in which different organizations share access to the same database, using the techniques described above. Database information may be transmitted to the indexer 1094, which may provide an index of information available in the database 1090 to file servers 1086. The QFS 1092 or other suitable filesystem may serve as a rapid-access file system for storing and accessing information available within the pod 1044. The QFS 1092 may support volume management capabilities, allowing many disks to be grouped together into a file system. The QFS 1092 may communicate with the database instances 1090, content search servers 1068 and/or indexers 1094 to identify, retrieve, move, and/or update data stored in the network file systems (NFS) 1096 and/or other storage systems.

In some implementations, one or more query servers 1082 may communicate with the NFS 1096 to retrieve and/or update information stored outside of the pod 1044. The NFS 1096 may allow servers located in the pod 1044 to access information over a network in a manner similar to how local storage is accessed. Queries from the query servers 1022 may be transmitted to the NFS 1096 via the load balancer 1028, which may distribute resource requests over various resources available in the on-demand database service environment 1000. The NFS 1096 may also communicate with the QFS 1092 to update the information stored on the NFS 1096 and/or to provide information to the QFS 1092 for use by servers located within the pod 1044.

In some implementations, the content batch servers 1064 may handle requests internal to the pod 1044. These requests may be long-running and/or not tied to a particular customer, such as requests related to log mining, cleanup work, and maintenance tasks. The content search servers 1068 may provide query and indexer functions such as functions allowing users to search through content stored in the on-demand database service environment 1000. The file servers 1086 may manage requests for information stored in the file storage 1098, which may store information such as documents, images, basic large objects (BLOBs), etc. The query servers 1082 may be used to retrieve information from one or more file systems. For example, the query system 1082 may receive requests for information from the app servers 1088 and then transmit information queries to the NFS 1096 located outside the pod 1044. The ACS servers 1080 may control access to data, hardware resources, or software resources called upon to render services provided by the pod 1044. The batch servers 1084 may process batch jobs, which are used to run tasks at specified times. Thus, the batch servers 1084 may transmit instructions to other servers, such as the app servers 1088, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

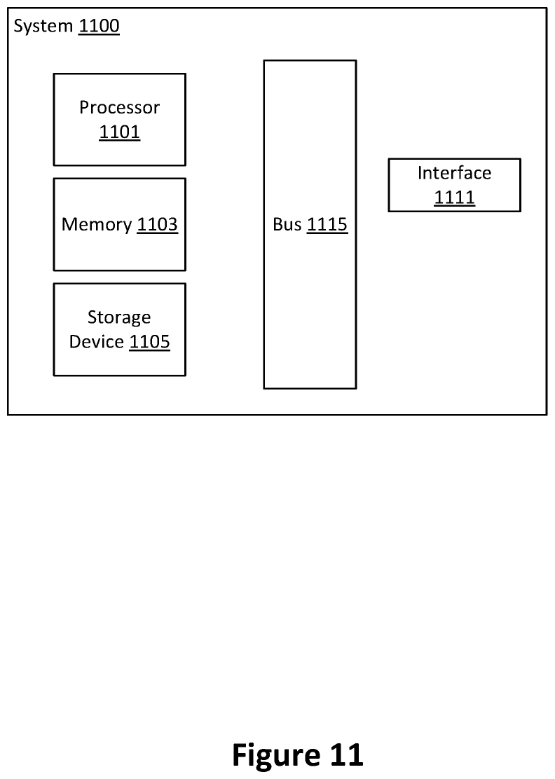

FIG. 11 illustrates one example of a computing device. According to various embodiments, a system 1100 suitable for implementing embodiments described herein includes a processor 1101, a memory module 1103, a storage device 1105, an interface 1111, and a bus 1115 (e.g., a PCI bus or other interconnection fabric.) System 1100 may operate as variety of devices such as an application server, a database server, or any other device or service described herein. Although a particular configuration is described, a variety of alternative configurations are possible. The processor 1101 may perform operations such as those described herein. Instructions for performing such operations may be embodied in the memory 1103, on one or more non-transitory computer readable media, or on some other storage device. Various specially configured devices can also be used in place of or in addition to the processor 1101. The interface 1111 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of on-demand computing environments that include MTSs. However, the techniques of disclosed herein apply to a wide variety of computing environments. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
receiving a definition for an attribute that is associated with an asset, wherein information from the asset is received for the attribute;
receiving a name for the attribute, wherein the name is used as a key in a key value pair for the attribute in a database;
storing a key value pair for the attribute in the database using the key of the name, wherein the value is associated with the information received from the asset that is monitoring the attribute; and
providing access to the value for the attribute using the key to monitor the attribute for the asset.

2. The method of claim 1, further comprising:
storing a virtual object for the attribute, the virtual object allowing access to the value via the key.

3. The method of claim 2, wherein the virtual object provides an interface to allow an operation referencing the name and the value for the attribute in a columnar approach to access the key value pair that is stored in a row.

4. The method of claim 3, wherein the virtual object stores an identifier to the asset.

5. The method of claim 2, wherein:
virtual object is associated with a standard object, and
the standard object stores the name and the value for the attribute in the key value pair in a row.

6. The method of claim 5, wherein the virtual object stores an identifier that references the standard object.

7. The method of claim 1, further comprising:
receiving a rule that uses the value of the attribute, wherein the rule references the name of the attribute.

8. The method of claim 7, wherein the rule sets a threshold to monitor based on the value of the attribute.

9. The method of claim 8, wherein the rule sets an operator for the threshold to monitor based on the value of the attribute.

10. The method of claim 7, wherein the rule references an identifier for the asset and the name of the attribute.

11. The method of claim 10, wherein the name of the attribute is used to look up the value of the attribute to apply a threshold to the value.

12. The method of claim 1, further comprising:
storing a plurality of attributes for the asset, wherein a key value pair is stored for respective attributes in the plurality of attributes.

13. The method of claim 1, further comprising:
receiving information from the asset;
determining a value for the attribute from the information; and
storing the value for the attribute using the key.

14. A computer program product comprising computer-readable program code capable of being executed by one or more processors when retrieved from a non-transitory computer-readable medium, the program code comprising instructions configurable to cause:
receiving a definition for an attribute that is associated with an asset, wherein information from the asset is received for the attribute;
receiving a name for the attribute, wherein the name is used as a key in a key value pair for the attribute in a database;
storing a key value pair for the attribute in the database using the key of the name, wherein the value is associated with the information received from the asset that is monitoring the attribute; and
providing access to the value for the attribute using the key to monitor the attribute for the asset.

15. A database system implemented using a server system, the database system configurable to cause:
receiving a definition for an attribute that is associated with an asset, wherein information from the asset is received for the attribute;
receiving a name for the attribute, wherein the name is used as a key in a key value pair for the attribute in a database;
storing a key value pair for the attribute in the database using the key of the name, wherein the value is associated with the information received from the asset that is monitoring the attribute; and
providing access to the value for the attribute using the key to monitor the attribute for the asset.

16. The database system of claim 15, further configurable to cause:
storing a virtual object for the attribute, the virtual object allowing access to the value via the key.

17. The database system of claim 16, wherein the virtual object provides an interface to allow an operation referencing the name and the value for the attribute in a columnar approach to access the key value pair that is stored in a row.

18. The database system of claim 15, further configurable to cause:
receiving a rule that uses the value of the attribute, wherein the rule references the name of the attribute.

19. The database system of claim 18, wherein the rule sets a threshold to monitor based on the value of the attribute.

20. The database system of claim 15, further configurable to cause:
storing a plurality of attributes for the asset, wherein a key value pair is stored for respective attributes in the plurality of attributes.
